(19) United States
(12) Patent Application Publication
(10) Pub. No.: US 2015/0158713 A1
(43) Pub. Date: Jun. 11, 2015

(54) WATER DISPENSER

(71) Applicant: KABUSHIKI KAISHA COSMO LIFE, Kakogawa-shi, Hyogo (JP)

(72) Inventor: Yoshinori Orita, Hyogo (JP)

(21) Appl. No.: 14/405,167

(22) PCT Filed: Apr. 12, 2013
(86) PCT No.: PCT/JP2013/061047

§ 371 Date: Dec. 3, 2014

(30) Foreign Application Priority Data
Jun. 5, 2012 (JP) 2012-128006

(51) Int. Cl. B67D 1/08; B67D 1/00

(52) U.S. Cl. CPC B67D 1/0829; B67D 1/0009

(57) ABSTRACT

A water dispenser is provided in which a water bottle is placed in the lower section, wherein a water outlet port of a cap of the water bottle can be smoothly fitted to a water flow rod. The water dispenser includes a housing (1) having a drawer space (20) at its lower portion, and a bottle holder (5) which can be moved into and out of the drawer space (20) with a replaceable water bottle (4) mounted thereon, which water bottle is formed flexible such that it collapses as the amount of remaining water decreases. The bottle holder (5) includes a bottle insertion port (24) into which a neck portion (11) of the water bottle (4) is inserted; an insertion guide surface (25) formed at the peripheral edge of a bottle insertion port (24); a bottle supporting surface (26) which supports a shoulder portion (10) of the water bottle (4), and a water flow rod (28) provided facing upward within the bottle insertion port (24).

### TECHNICAL FIELD

The present invention relates to a water dispenser which supplies drinking water from a replaceable water bottle filled with drinking water such as mineral water.

### BACKGROUND ART

Conventionally, water dispensers have been used primarily in offices and in hospitals. With a growing interest in water safety and health in recent years, however, water dispensers are gaining popularity among ordinary households. A well-known example of such water dispensers is one in which a replaceable water bottle is set to a bottle insertion port provided at the upper surface of a housing, as described in the below-identified Patent Document 1.

As the water bottle to be set to the water dispenser, a rigid bottle has been conventionally used, which does not collapse when the amount of remaining water is decreased. However, as described in Patent Document 1, a bottle formed flexible such that it collapses as the amount of remaining water decreases is increasingly employed in recent years, so that the empty bottles can be disposed of after use.

This water bottle comprises a hollow cylindrical trunk portion, a bottom portion provided at one end of the trunk portion, and a neck portion provided at the other end of the trunk portion through a shoulder portion. A cap is attached to the tip of the neck portion, and a plug body is detachably fitted into a water outlet port formed in the center of the cap. The bottom portion of the water bottle is provided with a handle for holding the water bottle with the neck portion of the water bottle facing downward. Further, a water flow rod is provided facing upward within the bottle insertion port placed at the upper surface of the housing, so that the water outlet port of the cap of the water bottle fits to the water flow rod when the neck portion of the water bottle is inserted into the bottle insertion port.

In the water dispenser disclosed in Patent Document 1, a fully filled water bottle needs to be lifted high when setting it, because the bottle insertion port is placed at the upper surface of the housing. However, the fully filled water bottle usually contains drinking water of about 12 liters, weighing 10 kg or more. Therefore, replacement of the water bottle was a tough task for water dispenser users (for women and senior citizens in particular).

In view of this, the present inventors have investigated for a water dispenser which allows for an easy replacement of the water bottle, and have invented as such a water dispenser, a water dispenser in which the water bottle is placed in the lower section.

The water dispenser in which the water bottle is placed in the lower section, invented by the present inventors, comprises a housing having a drawer space at its lower portion, and a bottle holder which can be moved into and out of the drawer space with a replaceable water bottle mounted thereon. The bottle holder is provided with a bottle insertion port into which the neck portion of the water bottle is inserted with the neck portion of the water bottle facing downward. Further, a water flow rod is provided facing upward within the bottle insertion port, so that the water outlet port of the cap of the water bottle fits to the water flow rod when the neck portion of the water bottle is inserted into the bottle insertion port.

The present water dispenser does not require a fully filled water bottle to be lifted high when setting it to the water dispenser and allows for an easy replacement of the water bottle, since the bottle holder is placed at the lower portion of the housing.

### PRIOR ART REFERENCES

### Patent Documents

Patent Document 1: JP 2012-46216 A (FIG. 1 and FIG. 3, in particular)

### SUMMARY OF THE INVENTION

### Problems to be Solved by the Invention

However, when the present inventors have made a water dispenser in which the water bottle is placed in the lower section for trial in-house, they have discovered that it is difficult to visually confirm the position of the water flow rod when setting the water bottle to the water dispenser, compared with a conventional water dispenser in which the water bottle is placed in the upper section, and that there is a possibility that the water outlet port of the cap of the water bottle cannot be smoothly fitted to the water flow rod.

In other words, in the conventional water dispenser in which the water bottle is placed in the upper section, the water outlet port of the cap of the water bottle can be fitted to the water flow rod while visually confirming the position of the water flow rod, since the bottle insertion port is provided at the upper surface of the housing. In the water dispenser in which the water bottle is placed in the lower section, on the other hand, the bottle insertion port is positioned near the operator's feet, and therefore, the water bottle comes to the position above and over the water flow rod seen from the viewpoint of the operator when fitting the water outlet port of the cap of the water bottle to the water flow rod, making it difficult to visually confirm the position of the water flow rod. Thus, it has been found that there is a possibility that the water outlet port of the cap of the water bottle cannot be smoothly fitted to the water flow rod.

In addition, when the water bottle is suspended by holding a handle provided at the bottom portion of the water bottle, with the neck portion of the water bottle facing downward, there are cases where the neck portion of the water bottle faces not directly but obliquely downward, depending on how the operator holds the handle. When the neck portion of the water bottle is facing obliquely downward, the fitting of the water outlet port of the cap of the water bottle to the water flow rod becomes further complicated.

An object of the present invention is to provide a water dispenser in which the water bottle is placed in the lower section, wherein the water outlet port of the cap of the water bottle can be smoothly fitted to the water flow rod.

### Means for Solving the Problems

In order to solve the above mentioned problems, the present invention has adopted the following constitution.

A water dispenser comprising: a housing having a drawer space at its lower portion, and a bottle holder configured to be moved into and out of the drawer space with a replaceable water bottle mounted thereon, wherein the water bottle is formed flexible so as to be collapsible as the amount of water remaining in the water bottle decreases;

wherein the water bottle comprises a hollow cylindrical trunk portion, a bottom portion provided at one end of the trunk portion, a handle provided at the bottom portion, a neck portion provided at the other end of the trunk portion through a shoulder portion, a cap attached to a tip of the neck portion, and a plug body detachably fitted to a water outlet port formed in a center of the cap; and

wherein the bottle holder comprises a bottle insertion port configured such that the neck portion of the water bottle can be inserted into the bottle insertion port with the neck portion of the water bottle facing downward; an insertion guide surface formed at a peripheral edge of the bottle insertion and sloping downward toward the bottle insertion port; a bottle supporting surface configured to support the shoulder portion of the water bottle when the neck portion of the water bottle is inserted into the bottle insertion port, the bottle supporting surface sloping so as to guide drinking water in the water bottle toward the neck portion of the water bottle; and a water flow rod provided facing upward within the bottle insertion port so that the water flow rod fits to the water outlet port of the cap when the neck portion of the water bottle is inserted into the bottle insertion port.

The present water dispenser does not require a fully filled water bottle to be lifted up so high when setting it to the water dispenser, and allows for an easy replacement of the water bottle, because the bottle holder is placed at the lower portion of the housing. Since, in the present water dispenser, the insertion guide surface sloping downward toward the bottle insertion port is formed at the peripheral edge of the bottle insertion port, the neck portion of the water bottle is guided to the bottle insertion port along the insertion guide surface, even if the position of the neck portion of the water bottle is not accurately brought to the position of the bottle insertion port when the neck portion of the water bottle is inserted into the bottle insertion port. Further, even in cases where the neck portion of the water bottle is facing not directly but obliquely downward, depending on the way the operator holds the handle at the bottom portion of the water bottle, the neck portion of the water bottle is guided to the bottle insertion port along the insertion guide surface. Thus, the water outlet port of the cap of the water bottle can be smoothly fitted to the water flow rod, even when it is difficult to visually confirm the position of the water flow rod, due to the water bottle being in the position above and over the water flow rod seen from the viewpoint of the operator. In addition, since the bottle supporting surface for supporting the shoulder portion of the water bottle is configured to form a slope, drinking water inside the water bottle can be fully used.

In order to simply align the water outlet port of the cap of the water bottle with the water flow rod, it would be preferable to set the height of the water flow rod such that the upper end of the water flow rod is positioned lower than the lower end of the insertion guide surface. This is because if the upper end of the water flow rod is positioned lower than the lower end of the insertion guide surface, the cap of the water bottle reaches the water flow rod after the neck portion of the water bottle 4 is guided to the position closest to the center of the bottle insertion port by the insertion guide surface, in the process of inserting the neck portion of the water bottle to the bottle insertion port, so that the water outlet port 13 of the cap 12 can be most reliably guided to the position of the water flow rod 28.

However, when a trial version of the water dispenser was actually made in which the upper end of the water flow rod is positioned lower than the lower end of the insertion guide surface, it was found that the flexible water bottle is deformed due to the counterforce acting on the cap from the water flow rod when the cap of the water bottle reached the water flow rod, and the deformation prevents the neck portion of the water bottle from being lowered sufficiently, and as a result, there is a possibility that the water outlet port of the cap may not be fitted to the water flow rod.

Therefore, the height of the water flow rod is preferably set such that the upper end of the water flow rod is positioned within a range higher than the lower end of the insertion guide surface and lower than the upper end of the insertion guide surface. With the above described configuration, the water outlet port of the cap can be reliably fitted to the water flow rod, even if the flexible water bottle is deformed due to the counterforce acting on the cap from the water flow rod when the cap of the water bottle reaches the water flow rod.

### Effect of the Invention

The water dispenser of the present invention allows for an easy replacement of the water bottle, since it is a low placement-type water dispenser in which the water bottle is mounted to the bottle holder placed at the lower portion of the housing. Further, since the insertion guide surface sloping downward toward the bottle insertion port is formed at the peripheral edge of the bottle insertion port, the water outlet port of the cap of the water bottle can be smoothly fitted to the water flow rod.

### BRIEF DESCRIPTION OF THE DRAWINGS

FIG. 1 is a side view of a water dispenser embodying the present invention.

FIG. 2 is an enlarged cross sectional view of the water bottle shown in FIG. 1.

FIG. 3 is a bottom view of the water bottle shown in FIG. 2.

FIG. 4 is a partial enlarged cross sectional view of the water dispenser shown in FIG. 1 illustrating the state in which the bottle holder is drawn out from the housing of the water dispenser.

FIG. 5 is a partial enlarged cross sectional view illustrating the process of setting the water bottle to the bottle holder shown in FIG. 4.

FIG. 6 is a view illustrating the state in which the setting of the water bottle shown in FIG. 5 is completed.

FIG. 7 is a view illustrating the state in which drinking water in the water bottle shown in FIG. 1 is being pump out.

FIG. 8 is a view illustrating the state in which drinking water in the water bottle shown in FIG. 1 is being pumped out, when the amount of water remaining in the water bottle is decreased.

FIG. 9 is a view illustrating the state in which the water bottle shown in FIG. 1 is drained of the drinking water.

### MODE FOR CARRYING OUT THE INVENTION

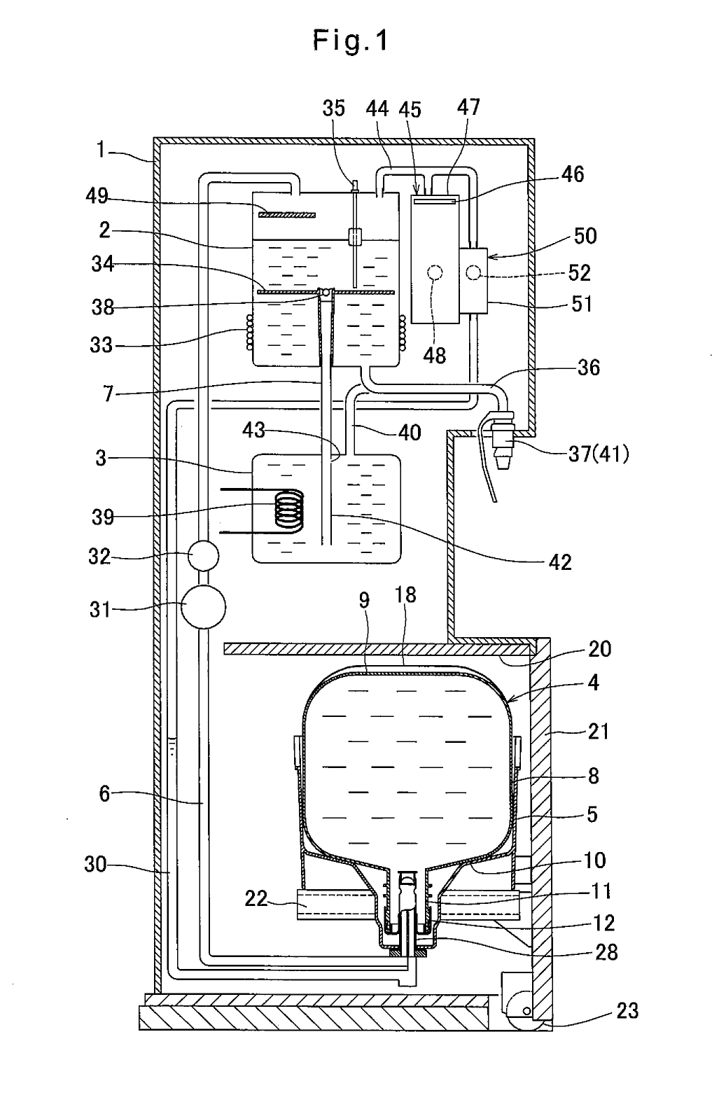

The water dispenser according the embodiment of the present invention is shown in FIG. 1. This water dispenser comprises a vertically elongated housing 1, a cold water tank 2 and a hot water tank 3 both mounted in the upper portion of the housing 1, a bottle holder 5 on which a replaceable water bottle 4 is to be mounted, a raw water supply passage 6 communicating between the water bottle 4 mounted on the bottle holder 5 and the cold water tank 2, and a tank connecting passage 7 connecting the cold water tank 2 to the hot water tank 3. The cold water tank 2 and the hot water tank 3 are arranged vertically in line such that the hot water tank 3 is positioned under the cold water tank 2.

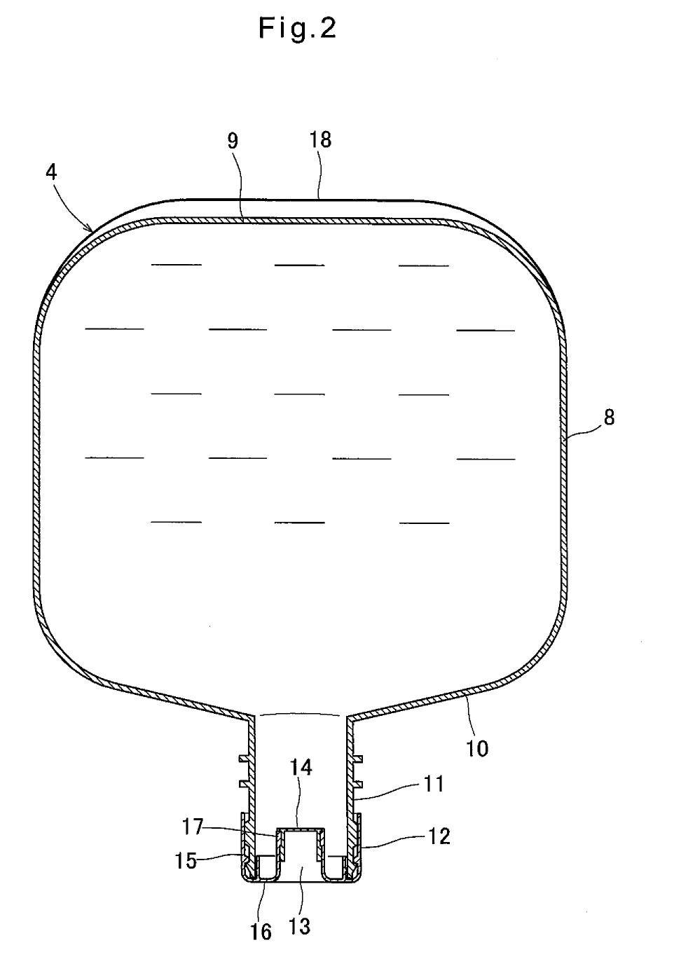

As shown in FIG. 2, the water bottle 4 comprises a hollow cylindrical trunk portion 8, a bottom portion 9 provided at one end of the trunk portion 8, and a neck portion 11 provided at the other end of the trunk portion 8 through a shoulder portion 10. The trunk portion 8 of the water bottle 4 is formed flexible so that the water bottle 4 collapses as the amount of remaining water decreases. The water bottle 4 can be formed by the blow molding of, for example, polyethylene terephthalate (PET) resin or polyethylene (PE) resin. The capacity of the water bottle 4 is about 12 liters when the bottle is fully filled.

A cap 12 is attached to the tip of the neck portion 11, and a plug body 14 is removably fitted into a water outlet port 13 formed in the center of the cap 12. The cap 12 comprises an outer cylindrical portion 15 which fits to the outer periphery of the neck portion 11, an annular plate portion 16 continuously provided at one end of the outer cylindrical portion 15, and an inner cylindrical portion 17 extending into the neck portion 11 from the radially inner edge of the annular plate portion 16. The inner cylindrical portion 17 is formed coaxially with the outer cylindrical portion 15. The outer cylindrical portion 15 intersects the annular plate portion 16 along a rounded ridge having a circular arc-shaped cross section. The inner cylindrical portion 17 and the annular plate portion 16 also intersect each other along a rounded ridge having a circular arc-shaped cross section. The space inside the inner cylindrical portion 17 forms the water outlet port 13, and the plug body 14 is fitted into the inner cylindrical portion 17.

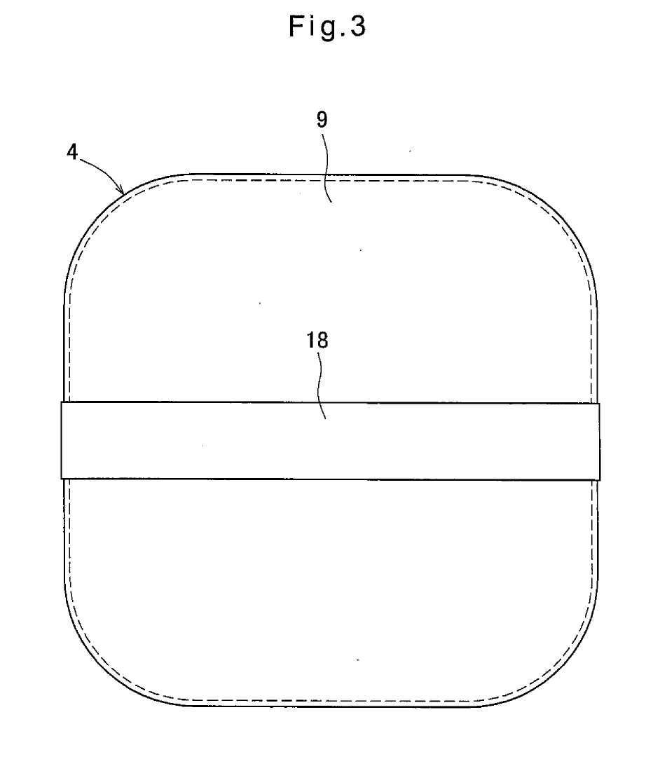

Further, the bottom portion 9 of the water bottle 4 is provided with a handle 18 for carrying the water bottle 4 with the neck portion 11 of the water bottle 4 facing downward. As shown in FIG. 3, the handle 18 is a belt-like body arranged to intersect the bottom portion 9 of the water bottle 4, with both ends of the handle adhesively fixed to the trunk portion 8 of the water bottle 4. As the handle 18, a resin molding attached to the center of the bottom portion 9 may also be used.

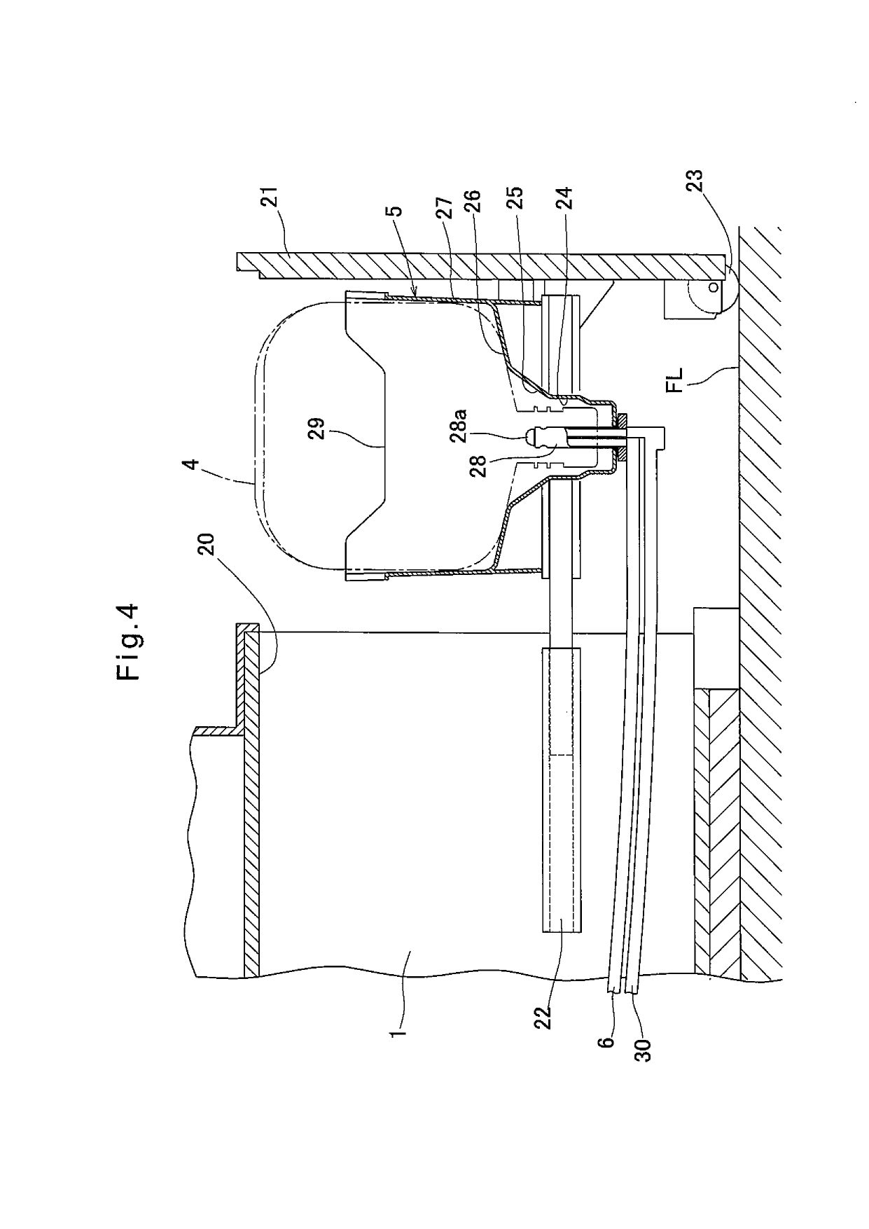

As shown in FIG. 4, the lower portion of the housing 1 is provided with a drawer space 20 into and out of which the bottle holder 5 can be moved, and a sliding door 21 which opens and closes the drawer space 20. The bottle holder 5 is horizontally slidably supported by a guide rail 22 provided within the drawer space 20, so that the bottle holder 5 can be moved into and out of drawer space 20 with the water bottle 4 mounted thereon.

The sliding door 21 is fixed to the bottle holder 5 so that the sliding door slides together with the bottle holder 5. Thus, when the sliding door 21 is opened, the bottle holder 5 is pulled out of the drawer space 20 at the same time. When the sliding door 21 is closed, the bottle holder 5 is housed within the drawer space 20 at the same time.

Rollers 23 are attached to the lower portion of the sliding door 21 so as to be kept in rolling contact with the mounting surface FL of the housing 1. The rollers 23 prevent the housing 1 from falling by supporting the weight of the water bottle 4, when the bottle holder 5 is drawn out from the drawer space 20 and the fully filled water bottle 4 is placed on the bottle holder 5.

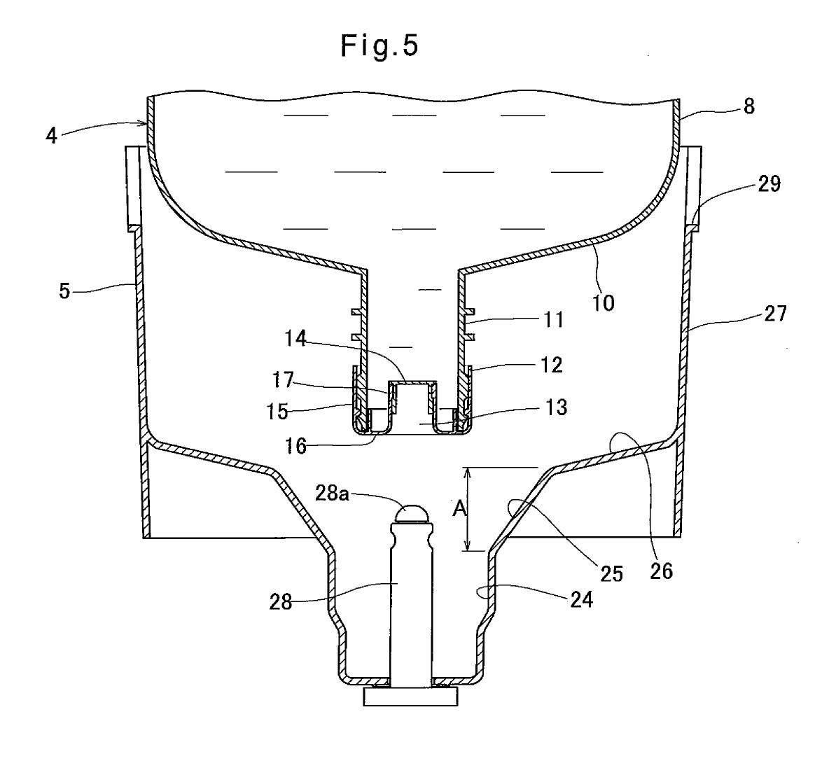

As shown in FIG. 5, the bottle holder 5 comprises a bottle insertion port 24 into which the neck portion 11 of the water bottle 4 is inserted with the neck portion 11 of the water bottle 4 facing downward; an insertion guide surface 25 formed at the peripheral edge of the bottle insertion port 24 such that the insertion guide surface 25 forms a downward slope toward the bottle insertion port 24; a bottle supporting surface 26 for supporting the shoulder portion 10 of the water bottle 4 when the neck portion 11 of the water bottle 4 is inserted into the bottle insertion port 24; a peripheral wall 27 extending upward from the outer peripheral edge of the bottle supporting surface 26; and a water flow rod 28 fixed in position facing upward within the bottle insertion port 24. The water flow rod 28 is a hollow cylindrical member extending in the vertical direction.

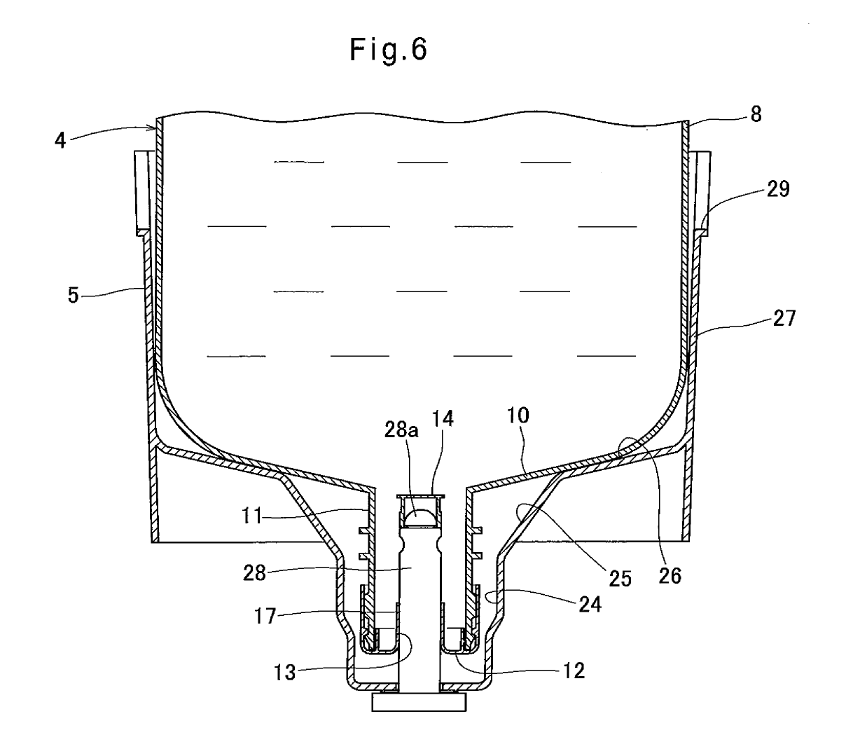

As shown in FIG. 6, the water flow rod 28 fits to the water outlet port 13 of the cap 12 when the neck portion 11 of the water bottle 4 is inserted into the bottle insertion port 24. The outer diameter of the water flow rod 28 is determined to be equal to or slightly greater than the inner diameter of the water outlet port 13 (that is, the inner diameter of the inner cylindrical portion 17) so that, when the water flow rod 28 is fitted to the water outlet port 13 of the cap 12, the leaking of water from between the fitting surfaces is prevented. At the tip of the water flow rod 28 is formed a protrusion 28a which maintains the plug body 14 in the water outlet port 13 when the water flow rod 28 is fitted to the water outlet port 13.

The bottle supporting surface 26 forms a slope so that the drinking water inside the water bottle 4 is guided to the neck portion 11 of the water bottle 4. The insertion guide surface 25 forms a slope steeper than that of the bottle supporting surface 26. As a result, the insertion guide surface 25 does not come into contact with the water bottle 4 when the shoulder portion 10 of the water bottle 4 is supported by the bottle supporting surface 26.

The inner periphery of the bottle insertion port 24 is a cylindrical surface configured to surround the neck portion 11 of the water bottle 4. Although the bottle supporting surface 26 is shown in the figures as a conical surface which is linear in cross section, it may be a tapered surface having a cross section of a slightly concave curve. Further, although the insertion guide surface 25 is shown in the figures as a conical surface which is linear in cross section and which has a larger inclination angle than that of the bottle supporting surface 26, it may be a tapered surface which is convexly curved in cross section.

As shown in FIG. 5, the height of the water flow rod 28 is determined such that the top end of the water flow rod 28 (that is, the top end of the protrusion 28a) is positioned within the range A, which is higher than the bottom end of the insertion guide surface 25 and lower than the top end of the insertion guide surface 25.

The peripheral wall 27 is formed to have a height greater than at least ½ of the length of the trunk portion 8 of the water bottle 4. When the amount of water remaining in the water bottle 4 is decreased and the water bottle 4 is collapsed, the peripheral wall 27 prevents the inclination of the trunk portion 8 of the water bottle 4, thus preventing the water bottle 4 from interfering with the inner surface of the drawer space 20. Thus, when the water bottle 4 becomes empty, the situation where the bottle holder 5 cannot be withdrawn from the drawer space 20 is prevented.

Further, as shown in FIG. 4, a recessed portion 29 is formed at the center of the top edge of the peripheral wall 27. The recessed portion 29 is wider than the outer diameter of the cap 12 at the tip of the neck portion 11 of the water bottle 4 so that the cap 12 can pass through the recessed portion 29. With this arrangement, when the fully filled water bottle 4 is set in the bottle holder 5, the height the water bottle 4 needs to be lifted up is reduced by an amount corresponding to the depth of the recessed portion 29, thereby reducing the burden of replacing the water bottle 4.

As shown in FIG. 1, to the bottom end of the water flow rod 28 are connected the end portion of the raw water supply passage 6 on the side of the water bottle 4, and the end portion of an air passage 30 for introducing air into the water bottle 4 on the side of the water bottle 4.

A pump 31 and a flow rate sensor 32 are installed midway along the raw water supply passage 6. The pump 31 is a gear pump which pumps out drinking water by rotating a pair of gears meshing with each other. As the pump 31, it is also possible to use a diaphragm pump which sucks and discharge drinking water by the reciprocation of a diaphragm. When the pump 31 is operated, the drinking water inside the raw water supply passage 6 is transferred from the water bottle 4 side toward the cold water tank 2, so that drinking water in the water bottle 4 is supplied to the cold water tank 2. Further, when the drinking water runs out in the raw water supply passage 6, the pump 31 transfers air inside the raw water supply passage 6 (including ozone-containing air) from the water bottle 4 side toward the cold water tank 2. If the drinking water in the raw water supply passage 6 runs out while the pump 31 is in operation, the flow rate sensor 32 is capable of detecting this fact.

The cold water tank 2 contains air and drinking water in upper and lower layers. A cooling device 33 is attached to the cold water tank 2 and is configured to cool the drinking water contained in the cold water tank 2. A baffle plate 34 is provided inside the cold water tank 2 and partitions the interior of the cold water tank 2 into upper and lower sections. The cooling device 33 is positioned at the lower outer periphery of the cold water tank 2, so that the drinking water in the cold water tank 2 below the baffle plate 34 is maintained at low temperature (about 5°).

A water level sensor 35 is installed to the cold water tank 2 and configured to detect the water level of the drinking water accumulated in the cold water tank 2. When the water level detected by the water level sensor 35 falls to a predetermined level, the pump 31 is actuated, and drinking water is supplied from the water bottle 4 to the cold water tank 2. The baffle plate 34 prevents the drinking water cooled by the cooling device 33 and accumulated in the lower portion of the cold water tank 2 from being stirred by the normal-temperature drinking water supplied from the water bottle 4 into the cold water tank 2, when drinking water is supplied from the water bottle 4 to the cold water tank 2.

A cold water discharge passage 36 is connected to the bottom surface of the cold water tank 2 such that low-temperature drinking water accumulated in the lower portion of the cold water tank 2 can be discharged to the outside through the cold water discharge passage 36. The cold water discharge passage 36 is provided with a cold water cock 37 capable of being operated from outside the housing 1, so that low temperature drinking water can be discharged from the cold water tank 2 into a cup or the like by opening the cold water cock 37. The capacity of the cold water tank 2 is lower than that of the water bottle 4, and is about from 2 to 4 liters.

A tank connecting passage 7 which connects together the cold water tank 2 and the hot water tank 3 has a top end open at the center of the baffle plate 34. A check valve 38 is provided at the end portion of the tank connecting passage 7 on the side of the cold water tank 2. The check valve 38 permits the flow of drinking water from the cold water tank 2 side toward the hot water tank 3, and restricts the flow of drinking water from the hot water tank 3 side toward the cold water tank 2.

The hot water tank 3 is filled with drinking water. A heating device 39 is mounted to the hot water tank 3, and is configured to heat the drinking water in the hot water tank 3 so that the drinking water in the hot water tank 3 is maintained at a high temperature (about 90° C.). While a sheathed heater is used as the heating device 39 in the example shown, a band heater may be used instead. The sheathed heater is a heating device that houses a heating wire which generates heat by electrification, inside a metal pipe, and is installed such that it extends through the peripheral wall of the hot water tank 3 and into the interior of the hot water tank 3. The band heater is a cylindrical heat generator in which a heating wire which generates heat by electrification is embedded, and is tightly attached around the outer periphery of the hot water tank 3.

A hot water discharge passage 40 is connected to the upper surface of the hot water tank 3 such that high temperature drinking water accumulated in the upper portion of the hot water tank 3 can be discharged to the outside through the hot water discharge 40. The hot water discharge passage 40 is provided with a hot water cock 41 capable of being operated from outside the housing 1, so that high temperature drinking water can be discharged from the hot water tank 3 into a cup or the like by opening the hot water cock 41. When drinking water is discharged from the hot water tank 3, the same amount of drinking water as the discharged drinking water flows into the hot water tank 3 from the cold water tank 2 through the tank connecting passage 7, so that the hot water tank 3 is constantly maintained fully filled. The capacity of the hot water tank 3 is about from 1 to 2 liters.

The tank connecting passage 7 includes an inner-tank pipe 42 extending downward from the upper surface of the hot water tank 3 into the interior of the hot water tank 3. The inner-tank pipe 42 has an open lower end near the bottom surface of the hot water tank 3, thereby preventing the ascending flow of high temperature drinking water heated by the heating device 39 from directly flowing into the inner-tank pipe 42 through the open lower end thereof. At the position close to the upper surface of the hot water tank 3, a small hole 43 for communicating the interior and the exterior of the inner-tank pipe 42 is formed in the inner-tank pipe 42.

An air sterilization chamber 45 is connected to the cold water tank 2 through an air introduction passage 44. The air sterilization chamber 45 comprises a hollow casing 47 in which an air inlet port 46 is formed, and an ozone generator 48 provided within the casing 47. The ozone generator 48 may be, for example, a low-pressure mercury lamp which irradiates ultraviolet light to the oxygen in the air to convert oxygen to ozone, or a silent discharge apparatus which applies an AC voltage between a pair of counter electrodes covered with insulators to convert oxygen between the electrodes to ozone. The air sterilization chamber 45 is maintained in a state in which the casing 47 is constantly filled with ozone, by electrifying the ozone generator 48 at regular intervals to generate ozone.

When the water level in the cold water tank 2 decreases, air is introduced into the cold water tank 2 through the air introduction passage 44 such that the pressure in the cold water tank 2 is maintained at atmospheric pressure. Since air introduced into the cold water tank 2 is sterilized with ozone by passing through the air sterilization chamber 45, the air inside the cold water tank 2 is maintained clean.

A diffuser plate 49 is provided In the cold water tank 2. The diffuser plate 49 is configured to diffuse the flow of drinking water discharged from the raw water supply passage 6 until it reaches the water surface of the drinking water accumulated in the cold water tank 2. The diffuser plate 49 increases the contact area between the drinking water discharged from the raw water supply passage 6 and ozone contained in the air in the cold water tank 2 (i.e. ozone flowing into the cold water tank 2 through the air sterilization chamber 45), thus improving the sanitation of the drinking water flowing into the cold water tank 2.

An ozone generating device 50 is connected to the end portion of the air passage 30 opposite from the water bottle 4. The ozone generating device 50 comprises a hollow casing 51 having an inlet port and an outlet port, and an ozone generator 52 provided inside the casing 51. The inlet port of the casing 51 is connected to the air introduction passage 44, and the outlet port of the casing 51 is connected to the air passage 30. As with the ozone generator 48 in the air sterilization chamber 45, the ozone generator 52 may be a low-pressure mercury lamp which irradiates ultraviolet light to the oxygen in the air to convert oxygen to ozone, a silent discharge apparatus which applies an AC voltage between a pair of counter electrodes covered with insulators to convert oxygen between the electrodes to ozone, or the like. The ozone generating device 50 operates in conjunction with the actuation of the pump 31 to generate ozone.

The raw water supply passage 6 and the air passage 30 are formed of materials having flexibility and ozone resistance, in order to permit sliding operation of the bottle holder 5 and to allow ozone generated by the ozone generating device 50 to pass therethrough. For example, the raw water supply passage 6 and the air passage 30 may be silicone tubes, fluorocarbon resin tubes, and/or fluorocarbon rubber tubes.

Examples of the usage of the above described water dispenser will be described below.

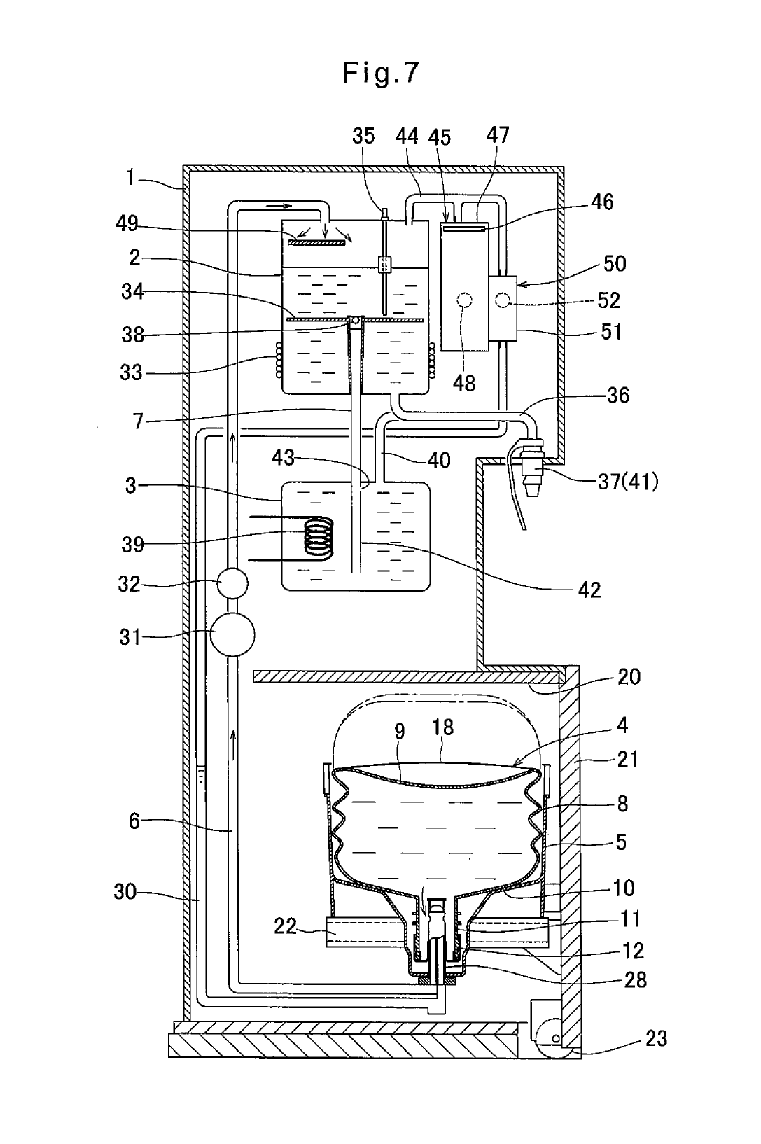

When a user of the water dispenser operates the cold water cock 37 to discharge low temperature drinking water in the cold water tank 2 into a cup or the like, the water level in the cold water tank 2 falls. Further, when the user operates the hot water cock 41 to discharge high temperature drinking water in the hot water tank 3 into a cup or the like, the water level in the cold water tank 2 also falls, because the same amount of drinking water as the discharged high temperature drinking water is introduced from the cold water tank 2 into the hot water tank 3 through the tank connecting passage 7. When the water level sensor 35 detects that the water level in the cold water tank 2 is below a predetermined lower limit water level, the pump 31 is actuated and supplies drinking water in the water bottle 4 to the cold water tank 2, as shown in FIG. 7. At the same time, the ozone generating device 50 generates ozone in conjunction with the actuation of the pump 31.

While, as shown in FIG. 7, there is still enough amount of water left in the water bottle 4 while the pump 31 is in operation, the water bottle 4 collapses as the drinking water in the water bottle 4 decreases due to atmospheric pressure, and therefore, the flow of air from the air passage 30 to the water bottle 4 does not occur.

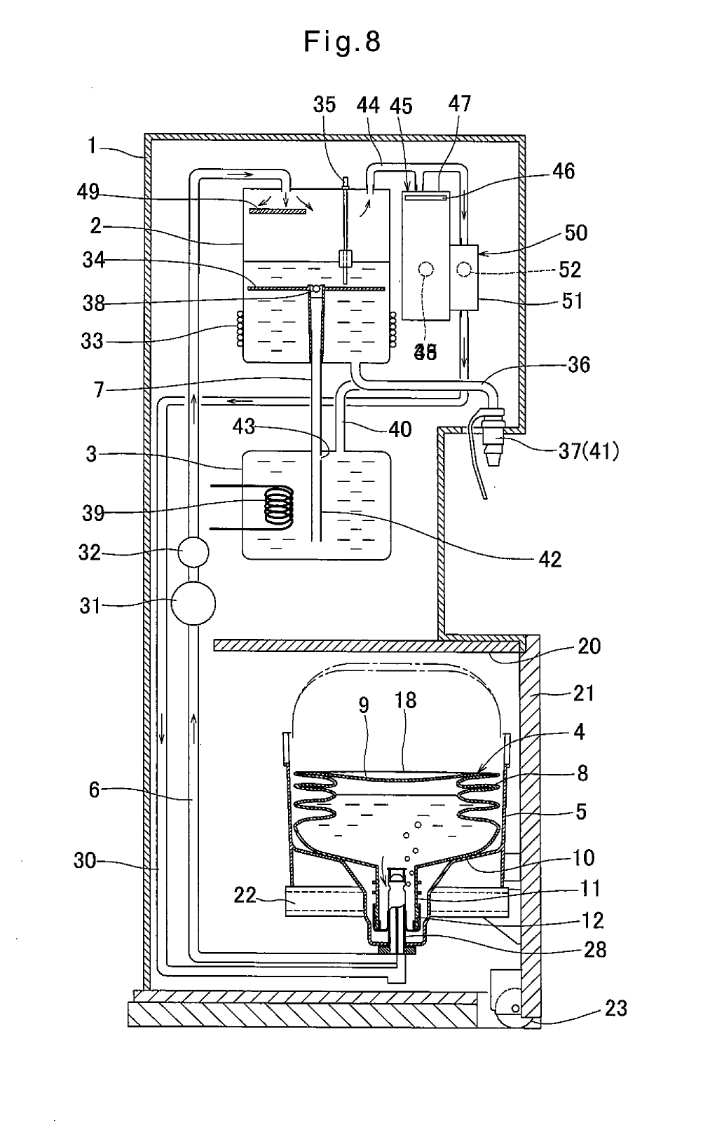

On the other hand, when the amount of water left in the water bottle 4 decreases to a certain level as shown in FIG. 8, the water bottle 4 is collapsed and its rigidity is increased to such an extent that it cannot be easily collapsed any further. Thus, at this stage, the pump 31 acts to reduce the pressure in the water bottle 4, thereby introducing air into the water bottle 4 from the air passage 30. Since ozone is being generated by the ozone generating device 50, the thus generated ozone also simultaneously flows into the water bottle 4 passing through the air passage 30 and then through the water flow rod 28, so that the interior of the air passage 30 and the interior of the water flow rod 28 are sterilized with ozone.

Further, when the amount of water remaining in the water bottle 4 decreases, the drinking water inside the water bottle 4 collects into the neck portion 11. Since the bottle supporting surface 26 is sloped, no water remains on the shoulder portion 10 of the water bottle 4, so that the drinking water in the water bottle 4 can be fully used.

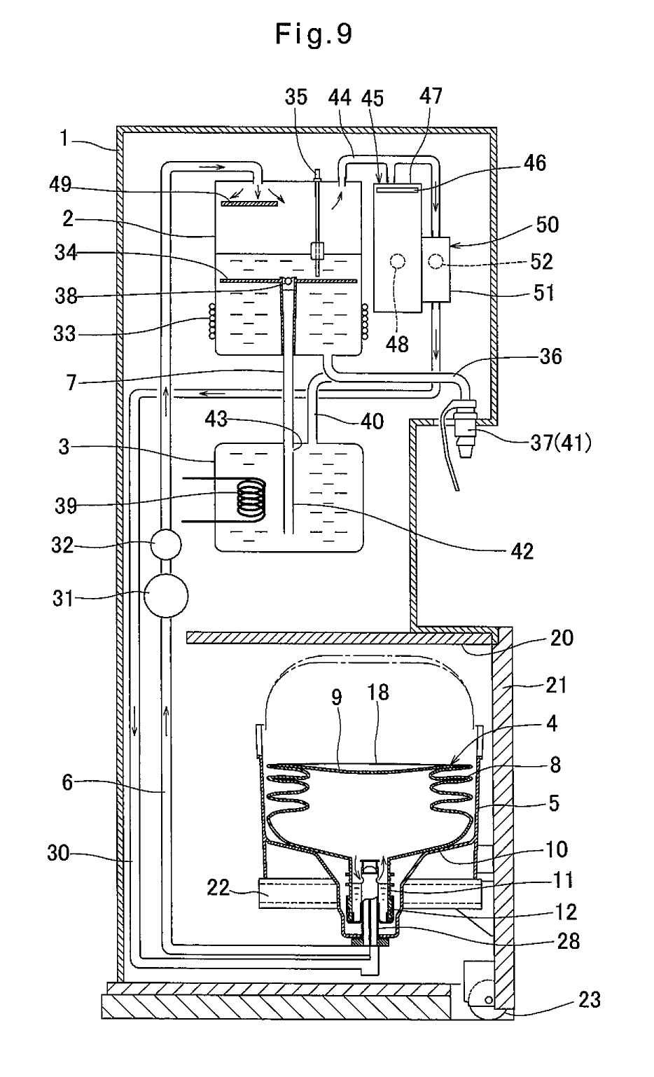

Then, as shown in FIG. 9, when the flow rate sensor 32 detects that there is no drinking water remaining in the raw water supply passage 6 while the pump 31 is in operation, the pump 31 and the ozone generating device 50 operate continuously for a predetermined period of time form that time point. At this time, the ozone generated by the ozone generating device 50 flows into the lower portion of the water bottle 4 passing through the air passage 30 and then through the water flow rod 28, and then further flows from the lower portion of the water bottle 4 into the cold water tank 2 passing through the water flow rod 28 and then through the raw water supply passage 6. Thus, the interior of the air passage 30, the interior of the water flow rod 28, and the interior of the raw water supply passage 6 are sterilized with ozone.

The water bottle 4 is then replaced with a new one. For this purpose, as shown in FIG. 4, the bottle holder 5 is first pulled out of the drawer space 20 of the housing 1, and the empty water bottle 4 is removed from the bottle holder 5. Next, as shown in FIG. 5, with the neck portion 11 facing down, a fully filled water bottle 4 is lifted up by holding the handle 18 provided at the bottom portion 9 of the water bottle 4, and is set in position in the bottle holder 5.

Since the bottle insertion port 24 is positioned near the operator's feet, the water bottle 4 comes to the position above and over the water flow rod 28 seen from the view point of the operator when fitting the water outlet port 13 of the of the cap 12 of the water bottle 4 to the water flow rod 28, making it difficult to visually confirm the position of the water flow rod 28.

However, since the insertion guide surface 25 is formed at the peripheral edge of the bottle insertion port 24 so as to be sloped downward toward the bottle insertion port 24, the neck portion 11 of the water bottle 4 is guided to the bottle insertion port 24 along the insertion guide surface 25, even if the neck portion 11 of the water bottle 4 is not accurately aligned with the bottle insertion port 24 when the neck portion 11 of the water bottle 4 is inserted into the bottle insertion port 24. Further, when holding the handle 18 at the bottom portion 9 of the water bottle 4, even if the neck portion 11 of the water bottle 4 faces not directly but obliquely downward by being held at the off-centered position of the handle 18, the neck portion 11 of the water bottle 4 is guided to the bottle insertion port 24 along the insertion guide surface 25. Thus, the water outlet port 13 of the cap 12 of the water bottle 4 can be smoothly fitted to the water flow rod 28.

In order to simply align the water outlet port 13 of the cap 12 of the water bottle 4 with the water flow rod 28, it would be preferable to set the height of the water flow rod 28 such that the upper end of the water flow rod 28 is positioned lower than the lower end of the insertion guide surface 25. This is because if the upper end of the water flow rod 28 is positioned lower than the lower end of the insertion guide surface 25, the cap 12 of the water bottle 4 reaches the protrusion 28a provided at the tip of the water flow rod 28 after the neck portion 11 of the water bottle 4 is guided to the position closest to the center of the bottle insertion port 24 by the insertion guide surface 25, in the process of inserting the neck portion 11 of the water bottle 4 to the bottle insertion port 24, so that the water outlet port 13 of the cap 12 can be most reliably guided to the position of the water flow rod 28.

However, in order for the water flow rod 28 to be inserted into the water outlet port 13 of the cap 12, the water flow rod 28 needs to pass through the inner cylindrical portion 17 while pushing out the plug body 14, and at the same time, a force in the axial direction needs to be applied between the cap 12 and the water flow rod 28. Therefore, if the upper end of the water flow rod 28 is actually positioned lower than the lower end of the insertion guide surface 25, the flexible water bottle 4 would be deformed due to the counterforce acting on the cap 12 from the water flow rod 28 when the cap 12 of the water bottle 4 reaches the water flow rod 28, which prevents the neck portion 11 of the water bottle 4 from being lowered sufficiently. As a result, there is a possibility that the water outlet port 13 of the cap 12 may not be fitted to the water flow rod 28.

Specifically, when the cap 12 of the water bottle 4 reaches the water flow rod 28, the water bottle 4 is deformed such that the shoulder portion 10 is recessed into the interior of the water bottle 4 due to the counterforce applied from the water flow rod 28. The deformation of the shoulder portion 10 causes the outer peripheral portion of the shoulder portion 10 of the water bottle 4 to come into contact with the bottle supporting surface 26 before the water flow rod 28 fits to the water outlet port 13 of the cap 12, and the weight of the drinking water in the water bottle 4 to be dispersed at the contact area. As a result, there is a possibility that sufficient force may not be applied between the cap 12 and the water flow rod 28, and the water outlet port 13 of the cap 12 may not be fitted to the water flow rod 28.

In contrast, as shown in FIG. 5, the height of the water flow rod 28 of the present water dispenser is set such that the upper end of the water flow rod 28 is positioned higher than the lower end of the insertion guide surface 25. With this arrangement, the water outlet port 13 of the cap 12 can be reliably fitted to the water flow rod 28 even if the flexible water bottle 4 is deformed due to the counterforce acting on the cap 12 from the water flow rod 28 when the cap 12 of the water bottle 4 reaches the water flow rod 28.

As described above, in the present water dispenser, the water outlet port 13 of the cap 12 of the water bottle 4 can be smoothly fitted to the water flow rod 28, because the insertion guide surface 25 is formed at the peripheral edge of the bottle insertion port 24 so as to slope downward toward the bottle insertion port 24.

In addition, since the bottle holder 5 is placed at the lower portion of the housing 1, the present water dispenser does not require a fully filled water bottle 4 to be lifted high when setting it to the water dispenser, and allows for an easy replacement of the water bottle 4.

Further, in the present water dispenser, the ozone generating device 50 generates ozone in conjunction with the actuation of the pump 31, and therefore, the ozone generated by the ozone generating device 50 flows through the air passage 30 when the air flows into the water bottle 4 from the air passage 30, and the interior of the air passage 30 is sterilized with ozone. Still further, every time when the replaceable water bottle 4 runs out of drinking water, both the air passage 30 and the raw water supply passage 6 are sterilized with ozone. Thus, the spread of bacteria within the air passage 30 and the raw water supply passage 6 is prevented and the water dispenser is kept sanitary.

### DESCRIPTION OF SYMBOLS

1 housing
4 water bottle
5 bottle holder
8 trunk portion
9 bottom portion
10 shoulder portion
11 neck portion
12 cap
13 water outlet port
14 plug body
18 handle
20 drawer space
24 bottle insertion port
25 insertion guide surface
26 bottle supporting surface
28 water flow rod

1. A water dispenser comprising: a housing (1) having a drawer space (20) at a lower portion thereof, and a bottle holder (5) configured to be moved into and out of the drawer space (20) with a replaceable water bottle (4) mounted thereon, wherein the water bottle is formed flexible so as to be collapsible as an amount of water remaining in the water bottle decreases;
wherein the water bottle (4) comprises a hollow cylindrical trunk portion (8), a bottom portion (9) provided at one end of the trunk portion (8), a handle (18) provided at the bottom portion (9), a neck portion (11) provided at another end of the trunk portion (8) through a shoulder portion (10), a cap (12) attached to a tip of the neck portion (11), and a plug body (14) detachably fitted to a water outlet port (13) formed in a center of the cap (12); and
wherein the bottle holder (5) comprises a bottle insertion port (24) configured such that the neck portion (11) of the water bottle (4) can be inserted into the bottle insertion port (24) with the neck portion (11) of the water bottle (4) facing downward; an insertion guide surface (25) formed at a peripheral edge of the bottle insertion port (24) and sloping downward toward the bottle insertion port (24); a bottle supporting surface (26) configured to support the shoulder portion (10) of the water bottle (4) when the neck portion (11) of the water bottle (4) is inserted into the bottle insertion port (24), the bottle supporting surface (26) sloping so as to guide drinking water in the water bottle (4) toward the neck portion (11) of the water bottle (4); and a water flow rod (28) provided facing upward within the bottle insertion port (24) so that the water flow rod fits to the water outlet port (13) of the cap (12) when the neck portion (11) of the water bottle (4) is inserted into the bottle insertion port (24).

2. The water dispenser according to claim 1, wherein the insertion guide surface (25) is a slope configured not to come into contact with the water bottle (4) when the shoulder portion (10) of the water bottle (4) is supported by the bottle supporting surface (26); and
wherein a height of the water flow rod (28) is set such that an upper end of the water flow rod (28) is positioned within a range higher than a lower end of the insertion guide surface (25) and lower than an upper end of the insertion guide surface (25).
